(19) United States
(12) Patent Application Publication
(10) Pub. No.: US 2014/0313234 A1
(43) Pub. Date: Oct. 23, 2014

(54) BRIGHTNESS CONTROL DEVICE AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHEN-HSUN LIAO, New Taipei (TW); XIAO-QIANG GONG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/065,657

(22) Filed: Oct. 29, 2013

(30) Foreign Application Priority Data
Apr. 18, 2013 (CN) 2013101350309

(51) Int. Cl. G09G 5/10

(52) U.S. Cl. CPC G09G 5/10
USPC 345/690

(57) ABSTRACT

A brightness control device includes a back light panel, a controller, and an image signal processing chip. The back light panel includes a blue light LED module and a green light LED module. The controller includes a converting module and a sub-control module. The image signal processing chip includes a main control module and a storing module. The storing module stores first corresponding data and second corresponding data. The main control module sends two initial pulse signals corresponding to a brightness of the two light LED modules to the converting module. The converting module converts the two initial pulse signals into direct current signals and sends the direct current signals to the sub-control module. The sub-control module sends a first drive current signal and a second drive current signal to the blue light LED module and the green light LED module.

### BACKGROUND

1. Technical Field

The present disclosure generally relates to a brightness control device and method.

2. Description of Related Art

Display devices include a back light panel including blue light LEDs and green light LEDs. A red phosphor is placed on each of the blue light LEDs and each of the green light LEDs. White light is emitted when blue light from the blue light LEDs and green light from the green light LEDs are emitted through the red phosphors and mixed. However, when the display sends a same current to the blue light LEDs and the green light LEDs, a brightness of the blue light LEDs and a brightness of the green light LEDs are different because the blue light LEDs and the green light LEDs have different properties. Therefore, a color imbalance may result in the display device.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a brightness control device.

FIG. 2 is a flow chart of one embodiment of a brightness control method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

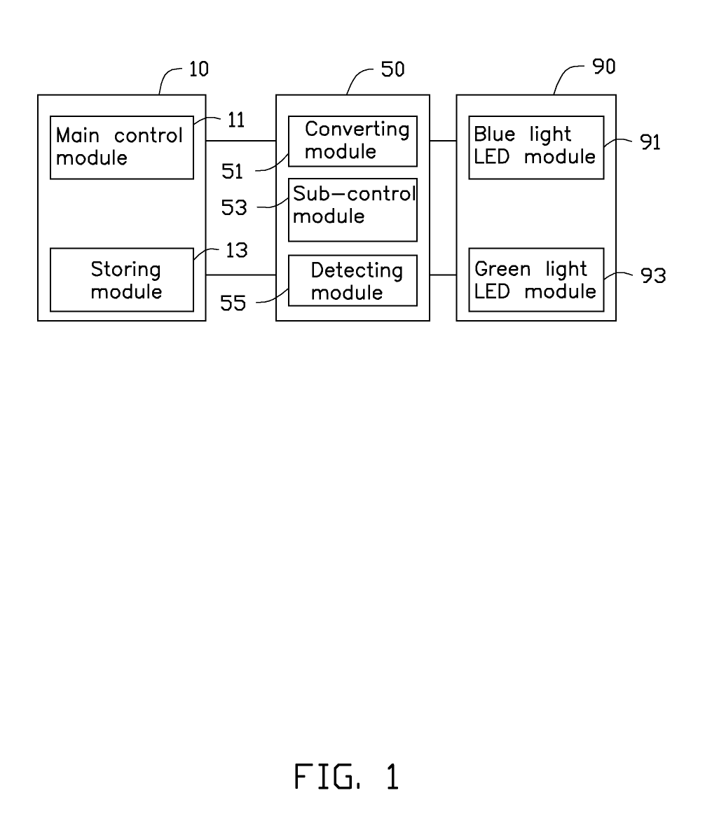

FIG. 1 shows a brightness control device according to one embodiment. The brightness control device includes an image signal processing (ISP) chip 10, a controller 50, and a back light panel 90. In one embodiment, a model of the ISP chip 10 is STDP7320-BB.

The controller 50 includes a converting module 51, a sub-control module 53, and a detecting module 55. The ISP chip 10 includes a main control module 11 and a storing module 13. The back light panel 90 includes a blue light LED module 91 and a green light LED module 93. In one embodiment, the blue light LED module 91 includes four blue light LEDs having a red phosphor placed thereon, and the green light LED module 93 includes four green light LEDs having a red phosphor placed thereon.

The storing module 13 stores first corresponding data between a duty cycle of pulse signals and a brightness of the blue light LEDs, and second corresponding data between a duty cycle of pulse signals and a brightness of the green light LEDs. The main control module 11 is configured to send a first initial pulse signal and a second initial pulse signal to the converting module 51. The first initial pulse signal corresponds to a brightness of the blue light LED, and the second initial pulse signal corresponds to the same brightness of the green light LED. The brightness of the blue light LED is set by a user. The converting module 51 converts the first initial pulse signal and the second initial pulse signal to a first direct-current (DC) signal and a second DC signal, respectively, and sends the first and second DC signals to the sub-control module 53. The sub-control module 53 produces a first drive current signal and a second drive current signal corresponding to the first direct current signal and the second direct current signal, respectively, and sends the first and second drive current signals to the blue light LED module 91 and the green light LED module 93, respectively. The detecting module 55 is configured to determine if current values of the blue light LED module 91 and the green light LED module 93 are associated with the first direct current signal and the second direct current signal, respectively. If not, the detecting module 55 sends an adjusting notice to the sub-control module 53 to adjust the first drive current signal or the second drive current signal.

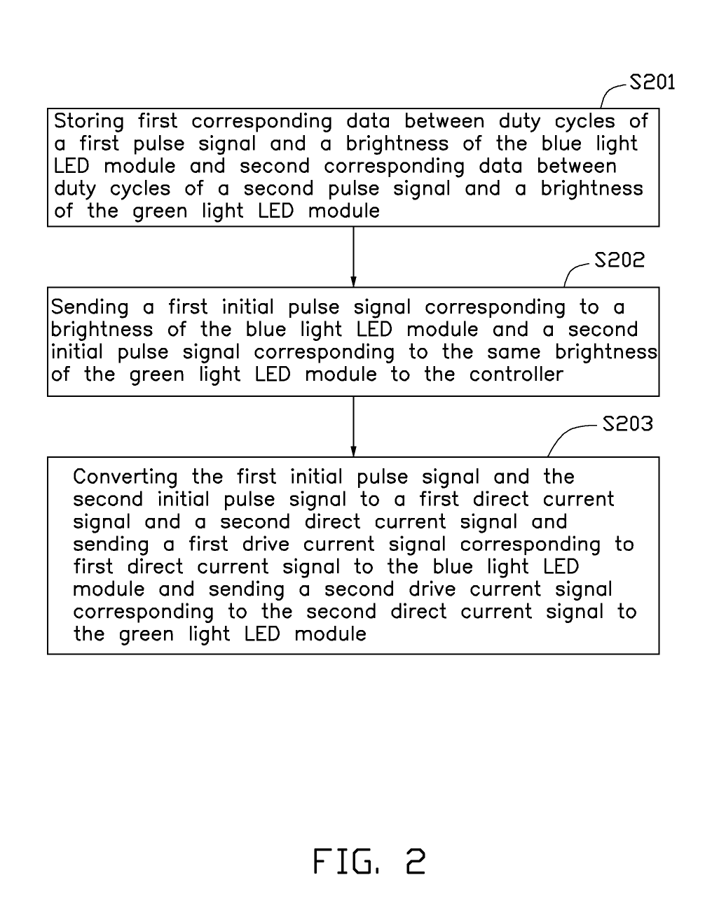

FIG. 2 shows that a brightness control method includes the following steps.

In step S201, the storing module 13 of the ISP chip 10 stores first corresponding data between a duty cycle of pulse signals and the brightness of the blue light LEDs, and second corresponding data between a duty cycle of the pulse signals and the brightness of the green light LEDs.

In step S202, the main control module 11 of the ISP chip 10 sends a first initial pulse signal corresponding to a brightness of the blue light LED and a second initial pulse signal corresponding to the same brightness of the green light LED to the converting module 51.

In step S203, the converting module 51 of the controller 50 converts the first initial pulse signal and the second initial pulse signal to the first direct current signal and the second direct current signal, respectively, and sends the first and second DC signals to the sub-control module 53. The sub-control module 53 generates a first drive current signal and a second drive current signal corresponding to the first direct current signal and the second direct current signal, respectively, and sends the first and second drive current signals to the blue light LED module 91 and the green light LED module 93, respectively. The detecting module 55 determines if the current values of the blue light LED module 91 and the green light LED module 93 are associated with the first direct current signal and the second direct current signal, respectively. If not, the detecting module 55 sends an adjusting notice to the sub-control module 53 to adjust the first drive current signal or the second drive current signal.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A brightness control device comprising:
a back light panel, the back light panel comprises a blue light LED module and a green light LED module;
a controller, the controller comprises a converting module and a sub-control module; and
an image signal processing chip, the image signal processing chip comprises a main control module and a storing module, the storing module stores first corresponding data between duty cycles of a first pulse signal and a brightness of the blue light LED module and second corresponding data between duty cycles of a second pulse signal and a brightness of the green light LED module; the main control module is configured to send a first initial pulse signal and a second initial pulse signal to the converting module; the first initial pulse signal corresponds to a brightness of the blue light LED module; and the second initial pulse signal corresponds to the same brightness of the green light LED module;
wherein the converting module is configured to convert the first initial pulse signal and the second initial pulse signal to a first direct current signal and a second direct current signal and send the first direct current signal and the second direct current signal to the sub-control module; the sub-control module is configured to send a first drive current signal, corresponding to the first direct current signal, to the blue light LED module and send a second drive current signal, corresponding to the second direct current signal, to the green light LED module.

2. The brightness control device of claim 1, wherein the controller further comprises a detecting module, the detecting module is configured to send an adjusting notice to the sub-control module, to adjust the first drive current signal, or the second drive current signal after determining that the current value of the blue light LED module is not associated with the first direct current signal or the current value of the green light LED module is not associated with the second direct current signal.

3. The brightness control device of claim 1, wherein the model of the image signal processing chip is STDP7320-BB.

4. The brightness control device of claim 1, wherein the blue light LED module comprises a plurality of blue light LED with red phosphor.

5. The brightness control device of claim 1, wherein the green light LED module comprises a plurality of green light LED with red phosphor.

6. A brightness control method, comprising:
providing a brightness control device, the brightness control device comprises a back light panel having a blue light LED module and a green light LED module, a controller, and an image signal processing chip; and the image signal processing chip stores first corresponding data between duty cycles of a first pulse signal and a brightness of the blue light LED module and second corresponding data between duty cycles of a second pulse signal and a brightness of the green light LED module;
sending, by the image signal processing chip, a first initial pulse signal and a second initial pulse signal; the first initial pulse signal corresponds to a brightness of the blue light LED module; and the second initial pulse signal corresponds to the same brightness of the green light LED module to the controller; and
converting, by the controller, the first initial pulse signal and the second initial pulse signal to a first direct current signal and a second direct current signal and sending a first drive current signal, corresponding to first direct current signal, to the blue light LED module and sending a second drive current signal, corresponding to the second direct current signal, to the green light LED module.

7. The brightness control method of claim 6, further adjusting the first drive current signal or the second drive current signal by the controller after determining that the current value of the blue light LED module is not associated with the first direct current signal or the current value of the green light LED module is not associated with the second direct current signal.

8. The brightness control method of claim 6, wherein the model of the image signal processing chip is STDP7320-BB.

9. The brightness control method of claim 6, wherein the blue light LED module comprises a plurality of blue light LED with red phosphor.

10. The brightness control method of claim 6, wherein the green light LED module comprises a plurality of green light LED with red phosphor.
